(19) United States
(12) Patent Application Publication
(10) Pub. No.: US 2024/0266676 A1
(43) Pub. Date: Aug. 8, 2024

(54) BATTERY PACK

(71) Applicant: APB CORPORATION, Fukui (JP)

(72) Inventors: Kazuya MINAMI, Kyoto (JP); Kenichi KAWAKITA, Kyoto (JP); Toshiaki YAMAGUCHI, Kyoto (JP); Ryosuke KUSANO, Kyoto (JP); Hideaki HORIE, Fukui (JP)

(21) Appl. No.: 18/566,995

(22) PCT Filed: Jun. 6, 2022
(86) PCT No.: PCT/JP2022/022729

§ 371 Date: Dec. 4, 2023

(30) Foreign Application Priority Data
Jun. 4, 2021 (JP) 2021-094346

(51) Int. Cl. H01M 50/474; H01M 4/66; H01M 10/04; H01M 10/52

(52) U.S. Cl. CPC H01M 50/474; H01M 4/668; H01M 10/0472; H01M 10/52

(57) ABSTRACT

Provided is a battery pack in which close contact between resin current collectors of vertically adjacent unit cells can be maintained. A battery pack includes: two or more unit cells including a stacked unit consisting of a set of a positive electrode resin current collector, a positive electrode active material layer, a separator, a negative electrode active material layer, and a negative electrode resin current collector stacked sequentially, a stacked body of the above-described two or more unit cells being enclosed in an exterior body; and an integrated insulator covering across boundaries between the above-described unit cells on at least one of the side surfaces of the above-described stacked body.

### RELATED APPLICATIONS

The present application is National Phase of International Application Number PCT/JP2022/022729, filed Jun. 6, 2022, and claims priority based on Japanese Patent Application No. 2021-094346, filed Jun. 4, 2021.

### TECHNICAL FIELD

The present invention relates to a battery pack.

### BACKGROUND ART

Lithium ion batteries have been widely used in recent years for various applications as secondary batteries that can achieve high energy density and high output density. A common lithium ion battery consists of a lamination of a plurality of substantially flat plate-shaped lithium secondary unit cells manufactured by providing a positive electrode active material layer and a negative electrode active material layer on one side of each current collector, sandwiching a separator between the active material layers, and stacking these positive and negative electrode active materials.

Among such lithium ion batteries formed by stacking a plurality of layers of unit cells, a resin current collector has been proposed as a current collector (refer to PTL 1).

In the case where a resin current collector is used as a current collector, the resin current collector has lower electron fluidity than a metal current collector, and therefore has a lower electrical conductivity. For this reason, when stacking a plurality of layers of unit cells, it is preferable that the resin current collectors located on the upper and lower surfaces of vertically adjacent unit cells be brought into close contact with each other, and efforts have been made to, for example, deaerate a flexible container when storing the stacked cell module in the container (refer to PTL 2).

### CITATION LIST

### Patent Literature

[PTL 1] Japanese Patent Application Publication No. 2010-62081

[PTL 2] Japanese Patent Application Publication No. 2017-45530

### SUMMARY OF INVENTION

### Technical Problem

However, even with these efforts, there is a problem that an internal resistance value of a battery pack increases due to misalignment of the vertically adjacent unit cells caused by external vibration during battery production, transportation, or use, or by generation of gases inside the cells due to storage, transportation, use, and the like at high temperatures.

The present invention has been made in consideration of the above-described problem, and an object of the present invention is to provide a battery pack in which close contact between resin current collectors of vertically adjacent unit cells can be maintained.

### Solution to Problem

The present inventors have conducted extensive studies, and as a result, they have realized the present invention.

That is, the present invention relates to a battery pack including: two or more unit cells including a stacked unit consisting of a set of a positive electrode resin current collector, a positive electrode active material layer, a separator, a negative electrode active material layer, and a negative electrode resin current collector stacked sequentially, a stacked body of the above-described two or more unit cells being enclosed in an exterior body; and an integrated insulator (A1) covering across boundaries between the above-described unit cells on at least one of the side surfaces of the above-described stacked body.

### Advantageous Effects of Invention

According to the present invention, it is possible to provide a battery pack in which close contact between resin current collectors of vertically adjacent unit cells can be maintained.

### BRIEF DESCRIPTION OF DRAWINGS

FIG. 1 is a cross-sectional view schematically illustrating one example of a battery pack of the present invention.

FIG. 2 is a perspective view schematically illustrating one example of a stacked body of the battery pack of the present invention.

FIG. 3 is a perspective view illustrating a mode in which an insulator is provided on side surfaces of the stacked body shown in FIG. 2.

FIG. 4 is a cross-sectional view taken along line A-A in FIG. 3.

FIG. 5 is a perspective view schematically illustrating another mode in which insulators are provided on side surfaces of the stacked body.

FIG. 6 is a perspective view schematically illustrating still another mode in which insulators are provided on side surfaces of the stacked body.

FIG. 7 is a perspective view schematically illustrating another mode in which an insulator is provided on a side surface of the stacked body.

FIG. 8 is a perspective view schematically illustrating still another mode in which insulators are provided on side surfaces of the stacked body.

FIG. 9 is a perspective view schematically illustrating still another mode in which insulators are provided on a side surface of the stacked body.

FIG. 10 is a cross-sectional view schematically illustrating one example of a battery pack having a buffering material between an exterior body and an insulator.

FIG. 11 is a cross-sectional view schematically illustrating one example of insulating tape having a three-layer structure of an insulator, a buffering material, and an insulator.

FIG. 12 is a cross-sectional view schematically illustrating one example of a battery pack in which the three-layer-structured insulating tape shown in FIG. 11 is placed between a stacked body and an exterior body.

FIG. 13 is a schematic view illustrating positions at which misalignment of unit cells is measured.

### DESCRIPTION OF EMBODIMENTS

Hereinafter, the present invention will be described in detail.

In the present specification, when referring to lithium ion batteries, the concept includes lithium ion secondary batteries.

A battery pack of the present invention includes: two or more unit cells including a stacked unit consisting of a set of a positive electrode resin current collector, a positive electrode active material layer, a separator, a negative electrode active material layer, and a negative electrode resin current collector stacked sequentially, a stacked body of the above-described two or more unit cells being enclosed in an exterior body; and an integrated insulator (A1) covering across boundaries between the above-described unit cells on at least one of the side surfaces of the above-described stacked body.

Specific embodiments of the battery pack of the present invention will be shown below.

Needless to say, the embodiments shown below are examples, and configurations shown in different embodiments can be partially replaced or combined. In the second and subsequent embodiments, description of matters shared by a first embodiment will not be repeated, and only different points will be described. In particular, similar effects due to similar configurations will not be mentioned sequentially for each embodiment.

### First Embodiment

A battery pack of a first embodiment includes: an integrated insulator (A1) on all side surfaces of a stacked body constituting the battery pack.

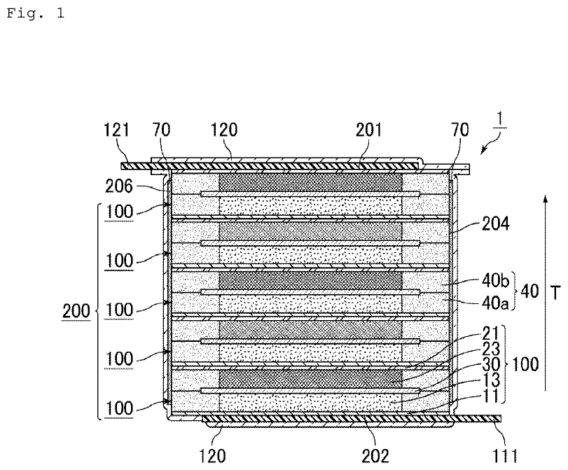

FIG. 1 is a cross-sectional view schematically illustrating one example of a battery pack of the present invention.

The structure of the battery pack other than the insulator will be described with respect to FIG. 1.

A battery pack 1 shown in FIG. 1 has five unit cells 100, and a stacked body 200 in which the unit cells 100 are stacked is enclosed in an exterior body 120.

Each unit cell 100 in which a positive electrode resin current collector 11, a positive electrode active material layer 13, a separator 30, a negative electrode active material layer 23, and a negative electrode resin current collector 21 are stacked in this order has the positive electrode resin current collector 11 and the negative electrode resin current collector 21 as outermost layers.

The positive electrode resin current collector 11, the positive electrode active material layer 13, the separator 30, the negative electrode active material layer 23, and the negative electrode resin current collector 21 constitute a stacked unit (electrode facing part).

The unit cell 100 has a frame member 40 placed around the above-described stacked unit between the positive electrode resin current collector 11 and the negative electrode resin current collector 21.

The frame member 40 fixes the peripheral edge of the separator 30 by sandwiching the separator 30 between a positive electrode frame member 40a and a negative electrode frame member 40b.

A high voltage tab 121 on a negative electrode side is connected to the negative electrode resin current collector 21 of the unit cell 100 located at the uppermost position and is drawn out of the exterior body 120.

Similarly, a high voltage tab 111 on a positive electrode side is connected to the positive electrode resin current collector 11 of the unit cell 100 located at the lowermost position and is drawn out of the exterior body 120.

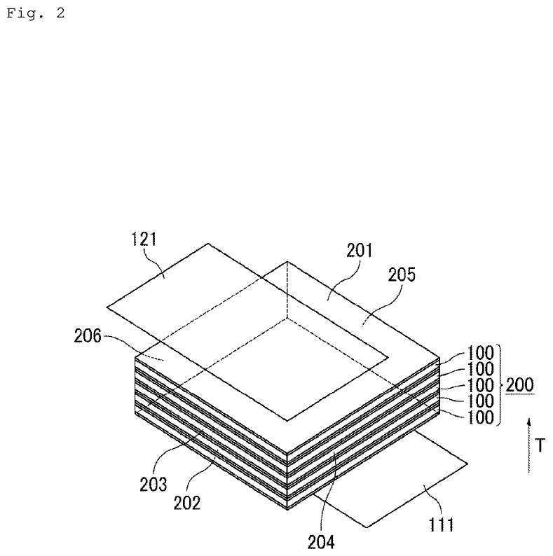

FIG. 2 is a perspective view schematically illustrating one example of a stacked body of the battery pack of the present invention.

The stacked body 200 shown in FIG. 2 has five unit cells 100 which are stacked.

The stacked body has a rectangular parallelepiped shape, and has an upper surface 201 and a lower surface 202 which are surfaces perpendicular to the direction in which the unit cells are stacked (arrow T direction), and four side surfaces, a first side surface 203, a second side surface 204, a third side surface 205, and a fourth side surface 206, parallel to the direction in which the unit cells are stacked.

The first side surface 203 and the third side surface 205 are two opposing side surfaces of the stacked body.

The second side surface 204 and the fourth side surface 206 are two opposing side surfaces of the stacked body.

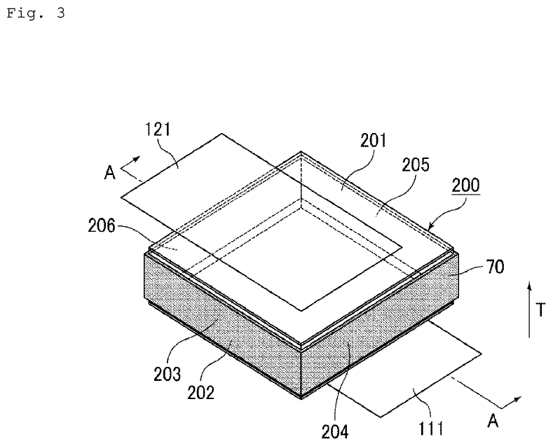

FIG. 3 is a perspective view illustrating a mode in which an insulator is provided on side surfaces of the stacked body shown in FIG. 2.

FIG. 3 shows a state in which an insulator 70 is provided on side surfaces of the stacked body 200 shown in FIG. 2.

The insulator 70 is an insulator that is continuous across all the side surfaces, the first side surface 203, the second side surface 204, the third side surface 205, and the fourth side surface 206, of the stacked body.

In the present specification, an insulator which coming into contact with the side surfaces of the stacked body and covers across the boundaries between the unit cells is denoted as an insulator (A1).

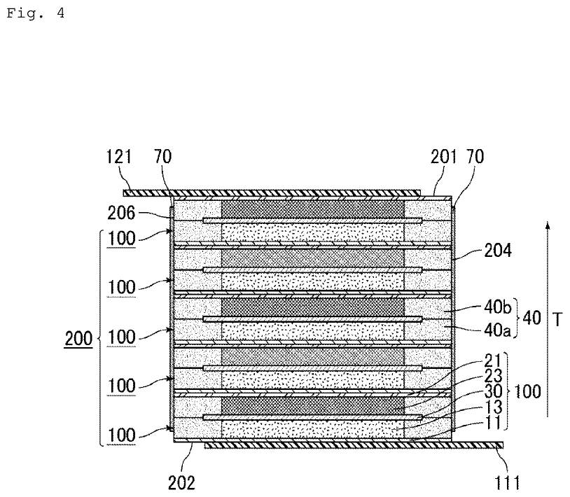

FIG. 4 is a cross-sectional view taken along line A-A in FIG. 3.

FIG. 4 shows a state where the insulator 70 covers across the boundaries between the unit cells 100 on the second side surface 204 and the fourth side surface 206 of the stacked body 200.

A boundary between unit cells 100 is a boundary between a negative electrode resin current collector 21 of a lower unit cell 100 and a positive electrode resin current collector 11 of an upper unit cell 100. In the stacked body 200 shown in FIG. 4, there are four boundaries between the unit cells 100. The integrated insulator 70 covers across all of the four boundaries.

The battery pack of the present invention includes the integrated insulator (Al) covering across the boundaries between the unit cells on the side surfaces of the stacked body, and therefore, close contact between resin current collectors of the vertically adjacent unit cells can be maintained.

In the present specification, the expression “integrated insulator covering across the boundaries between the unit cells” means that the boundaries between the unit cells on the side surfaces of the stacked body are covered with an insulator which is a single, non-separated member. In addition, although the insulator covers across the boundaries between the unit cells in the thickness direction of the stacked body, it is unnecessary to cover all of the side surfaces of the stacked body.

As in each of the embodiments to be described below, an insulator may be provided to the extent necessary to maintain close contact between the resin current collectors of the vertically adjacent unit cells, and some of the side surfaces of the stacked body may not be covered with an insulator.

Insulating tape can be preferably used as an insulator.

The insulating tape preferably has an insulation resistance of 1,000 MΩ or more.

In addition, the insulating tape preferably has a thickness of 10 to 200 μm.

Examples of insulating tape include Curing P-Cut Tape (manufactured by Teraoka Seisakusho Co., Ltd.), Kapton (registered trademark) adhesive tape (manufactured by Teraoka Seisakusho Co., Ltd.), masking tape 243J Plus (manufactured by 3M), and Sellotape (registered trademark) (manufactured by Nichiban Co., Ltd.).

The insulator (A1) is preferably made of a material having a peeling adhesive strength of 0.5 N/25 mm or more to a PET plate on at least one surface thereof. The insulator (A1) preferably covers across the boundaries between the unit cells with the surface having the adhesive strength.

The peeling adhesive strength of an insulator to a PET plate can be measured according to JIS Z 0237. The insulator whose peeling adhesive strength can be measured is a material whose surface has adhesive strength to a PET plate.

A 25 mm wide PET plate is used as a test piece, the surface of an insulator whose adhesive strength is to be measured is brought into contact with the PET plate and pressed with a roller to adhere the test piece on the PET plate, and the 180° peeling adhesive strength is measured according to JIS Z 0237.

If the peeling adhesive strength is 0.5 N/25 mm or more, misalignment of unit cells is less likely to occur. In addition, the peeling adhesive strength may be 55 N/25 mm or less.

Hereinafter, preferred aspects of each constituent element constituting a unit cell will be described.

First, each element forming a lamination unit of a unit cell will be described.

In a unit cell, it is preferable that a positive electrode active material layer and/or a negative electrode active material layer contain coated electrode active material particles in which at least a part of the electrode active material particle surface is coated with a coating layer and be unbound bodies of the coated electrode active material particles.

If a positive electrode active material layer and/or a negative electrode active material layer are unbound bodies of coated electrode active material particles, when unit cells are stacked and pressurized, the coated electrode active material particles can flow according to applied pressure due to the flexible positive electrode active material layer and/or negative electrode active material layer. For this reason, no unevenness is formed on the surface of the unit cells. If no unevenness is formed on the surface of the unit cells, wear and tear of a resin current collector can be suppressed.

The above-described aspect in the description of the positive electrode active material layer and the negative electrode active material layer will be described.

The positive electrode active material layer contains positive electrode active material particles.

Examples of positive electrode active material particles include composite oxides of lithium and transition metals {composite oxides containing one type of transition metal (such as LiCoO₂, LiNiO₂, LiAlMnO₄, LiMnO₂, and LiMn₂O₄), composite oxides containing two types of transition metal elements (for example, LiFeMnO₄, LiNi₁₋ₓCoₓO₂, LiMn_{1-y}Co_{y}O₂, LiNi_{1/3}Co_{1/3}Al_{1/3}O₂, and LiNi_{0.8}Co_{0.15}Al_{0.05}O₂), and composite oxides containing three or more types of metal elements [for example, LiMₐM′_{b}M″_{c}O₂ (where M, M″, and M″ are respectively different transition metal elements, satisfying a+b+c=1, for example, LiNi_{1/3}Mn_{1/3}Co_{1/3}O₂)]}, lithium-containing transition metal phosphates (such as LiFePO₄, LiCoPO₄, LiMnPO₄ and LiNiPO₄), transition metal oxides (for example, MnO₂ and V₂O₅), transition metal sulfides (for example, MoS₂ and TiS₂), and conductive polymers (for example, polyaniline, polypyrrole, polythiophene, polyacetylene, poly-p-phenylene, and polyvinylcarbazole), and two or more kinds thereof may be used in combination.

In lithium-containing transition metal phosphate, some transition metal sites may be substituted with other transition metals.

Positive electrode active material particles are preferably coated positive electrode active material particles coated with a coating layer.

The coating layer is a layer consisting of a conductive assistant and a polymer compound.

If positive electrode active material particles are coated with a coating layer, change in volume of the electrode is moderated, whereby expansion of the electrode can be suppressed.

Examples of conductive assistants include metal-based conductive assistants [such as aluminum, stainless steel (SUS), silver, gold, copper, and titanium], carbon-based conductive assistants [such as graphite and carbon black (such as acetylene black, ketjen black, furnace black, channel black, and thermal lamp black)] and mixtures thereof.

These conductive assistants may be used alone or in combination of two or more thereof. In addition, alloys or metal oxides of these may be used.

Among these, from the viewpoint of electrical stability, aluminum, stainless steel, silver, gold, copper, titanium, carbon-based conductive assistants, and mixtures thereof are more preferable, silver, gold, aluminum, stainless steel, and carbon-based conductive assistants are still more preferable, and carbon-based conductive assistants are particularly preferable.

In addition, these conductive assistants may be those in which a particle-based ceramic or resin material is coated with a conductive material [preferably with a metal among the above-described conductive assistants] by plating or the like.

The shape (form) of a conductive assistant is not limited to the particle form, and may be in a form other than the particle form, and may be in a form that is in practical use as a so-called filler-based conductive assistant such as a carbon nanofiber or a carbon nanotube.

The ratio of a polymer compound to a conductive assistant is not particularly limited, but from the viewpoint of internal resistance or the like of a battery, the weight ratio of a polymer compound (resin solid content weight) to a conductive assistant is preferably 1:0.01 to 1:50 and more preferably 1:0.2 to 1:3.0.

As polymer compounds, those disclosed in Japanese Patent Application Publication No. 2017-054703 as resins for coating non-aqueous secondary battery active materials can be suitably used.

In addition, the positive electrode active material layer may contain conductive assistants in addition to the conductive assistants contained in a coated positive electrode active material.

As the conductive assistants, the same conductive assistants described above contained in the coated positive electrode active material can be suitably used.

The coating layer may further contain ceramic particles.

Examples of ceramic particles include metal carbide particles, metal oxide particles, and glass-ceramic particles.

Examples of metal carbide particles include silicon carbide (SiC), tungsten carbide (WC), molybdenum carbide (Mo₂C), titanium carbide (TiC), tantalum carbide (TaC), niobium carbide (NbC), vanadium carbide (VC), and zirconium carbide (ZrC).

Examples of metal oxide particles include zinc oxide (ZnO), aluminum oxide (Al₂O₄), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LiNbO₃, LiAlO₂, Li₂ZrO₃, Li₂WO₄, Li₂TiO₃, Li₃PO₄, Li₂MoO₄, Li₃BO₃, LiBO₂, Li₂CO₃, Li₂SiO₃, and perovskite-type oxide particles represented by ABO₃ (provided that A is at least one selected from the group consisting of Ca, Sr, Ba, La, Pr, and Y, and B is at least one selected from the group consisting of Ni, Ti, V, Cr, Mn, Fe, Co, Mo, Ru, Rh, Pd, and Re).

As metal oxide particles, zinc oxide (ZnO), aluminum oxide (Al₂O₃), silicon dioxide (SiO₂), and lithium tetraborate (Li₂B₄O₇) are preferable from the viewpoint of suitably suppressing a side reaction caused between an electrolytic solution and coated positive electrode active material particles.

As ceramic particles, glass-ceramic particles are preferable from the viewpoint of suitably suppressing a side reaction caused between an electrolytic solution and coated positive electrode active material particles.

These may be used alone or in combination of two or more thereof.

As glass-ceramic particles, a lithium-containing phosphoric acid compound having a rhombohedral system is preferable, and a chemical formula thereof is represented by LiₓM″₂P₃O₁₂ (X=1 to 1.7).

Here, M″ is one or more elements selected from the group consisting of Zr, Ti, Fe, Mn, Co, Cr, Ca, Mg, Sr, Y, Sc, Sn, La, Ge, Nb, and Al. In addition, a part of P may be substituted with Si or B, and a part of O may be substituted with F, Cl, or the like. For example, Li_{1.15}Ti_{1.85}Al_{0.15}Si_{0.05}P_{2.95}O₁₂, Li_{1.2}Ti_{1.8}Al_{0.1}Ge_{0.1}Si_{0.05}P_{2.95}O₁₂, and the like can be used.

In addition, materials with different compositions may be mixed with each other or composited, or the surface may be coated with a glass electrolyte or the like. Alternatively, it is preferable to use glass-ceramic particles that precipitate a crystal phase of a lithium-containing phosphoric acid compound having a NASICON-type structure through heat treatment.

Examples of glass electrolytes include glass electrolytes disclosed in Japanese Patent Application Publication No. 2019-96478.

Here, the formulation proportion of Li₂O in glass-ceramic particles is preferably 8 mass % or less in terms of oxide.

A solid electrolyte which consists of Li, La, Mg, Ca, Fe, Co, Cr, Mn, Ti, Zr, Sn, Y, Sc, P, Si, O, In, Nb, and F, has a crystal structure of an LISICON type, perovskite type, a β-Fe₂(SO₄)₃ type, and a Li₃In₂(PO₄)₃ type instead of the NASICON-type structure, and conducts Li ions at 1×10⁻⁵ S/cm or more at room temperature may be used.

The above-described ceramic particles may be used alone or in combination of two or more thereof.

The volume average particle diameter of the ceramic particles is preferably 1 to 1,000 nm, more preferably 1 to 500 nm, and still more preferably 1 to 150 nm from the viewpoints of energy density and electrical resistance values.

The weight proportion of the ceramic particles is preferably 0.5 to 5.0 weight % based on the weight of coated positive electrode active material particles.

By incorporating ceramic particles within the above-described range, it is possible to suitably suppress a side reaction caused between an electrolytic solution and coated positive electrode active material particles.

The weight proportion of the ceramic particles is more preferably 2.0 to 4.0 weight % based on the weight of coated positive electrode active material particles.

The positive electrode active material layer is preferably an unbound body which contains a positive electrode active material but does not contain a binding material that binds positive electrode active materials.

Here, an unbound body means that positive electrode active materials are not bound to each other, and binding means that positive electrode active materials are irreversibly fixed to each other.

The positive electrode active material layer may contain an adhesive resin.

As adhesive resins, for example, one obtained by mixing a small amount of organic solvent with a resin for coating a non-aqueous secondary battery active material disclosed in Japanese Patent Application Publication No. 2017-054703 and adjusting the glass transition temperature of the mixture to below room temperature and those disclosed in Japanese Patent Application Publication No. H10-255805 as adhesives can be suitably used.

An adhesive resin means a resin that has adhesiveness (a property of bonding by applying slight pressure without using water, a solvent, heat, and the like) without solidifying even if a solvent component is evaporated and dried. On the other hand, a solution-drying electrode binder used as a binding material means one that dries and solidifies by volatilizing a solvent component to firmly bond and fix active materials to each other.

Accordingly, the solution-drying electrode binder (adhesive resin) and the adhesive resin are different materials.

The thickness of the positive electrode active material layer is not particularly limited, but is preferably 100 to 700 μm and more preferably 300 to 600 μm from the viewpoint of battery performance.

The negative electrode active material layer contains negative electrode active material particles.

As negative electrode active material particles, well-known negative electrode active materials for lithium ion batteries can be used, and examples thereof include carbon-based materials (such as graphite, non-graphitizable carbon, amorphous carbon, resin fired bodies (for example, ones obtained by firing and carbonizing a phenolic resin, a furan resin, and the like), cokes (for example, pitch coke, needle coke, and petroleum coke), and carbon fibers], silicon-based materials [such as silicon, silicon oxide (SiOx), silicon-carbon composites (ones obtained by coating surfaces of carbon particles with silicon and/or silicon carbide, ones obtained by coating surfaces of silicon particles or silicon oxide particles with carbon and/or silicon carbide, and silicon carbide), and silicon alloys (such as silicon-aluminum alloys, silicon-lithium alloys, silicon-nickel alloys, silicon-iron alloys, silicon-titanium alloys, silicon-manganese alloys, silicon-copper alloys, and silicon-tin alloys)], conductive polymers (for example, polyacetylene and polypyrrole), metal (tin, aluminum, zirconium, and titanium), metal oxides (such as titanium oxide and lithium titanate oxide), metal alloys (for example, lithium-tin alloys, lithium-aluminum alloys, and lithium-aluminum-manganese alloys), and mixtures of these with carbon-based materials.

In addition, negative electrode active material particles may be coated negative electrode active material particles coated with the same coating layer as that for the above-described coated positive electrode active material particles.

As a conductive assistant, a polymer compound, and ceramic particles constituting a coating layer, the same conductive assistant, polymer compound, and ceramic particles as those for the above-described coated positive electrode active material particles can be suitably used.

In addition, the negative electrode active material layer may contain conductive assistants in addition to the conductive assistants contained in the coated negative electrode active material particles. As the conductive assistants, the same conductive assistants described above contained in the coated positive electrode active material particles can be suitably used.

The negative electrode active material layer is preferably an unbound body which does not contain a binding material that binds negative electrode active materials similarly to the positive electrode active material layer. In addition, an adhesive resin may be contained similarly to the positive electrode active material layer.

The thickness of the negative electrode active material layer is not particularly limited, but is preferably 100 to 900 μm, 300 to 800 μm, or 500 to 700 μm from the viewpoint of battery performance.

The thickness of the positive electrode active material layer may be the same as or different from the thickness of the negative electrode active material layer, and the thickness of the negative electrode active material layer may be thicker than that of the positive electrode active material layer.

A positive electrode resin current collector and a negative electrode resin current collector are resin current collectors made of a conductive polymer material.

The thickness of the positive electrode resin current collector and the negative electrode resin current collector is not particularly limited but is preferably 50 to 500 μm for each of the positive electrode resin current collector and the negative electrode resin current collector.

As a conductive polymer material constituting a resin current collector, for example, a conductive polymer or a resin to which a conductive agent is added as necessary can be used.

As the conductive agent constituting the conductive polymer material, the same conductive assistants described above contained in the coated positive electrode active material can be suitably used.

Examples of resins constituting the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA) , polyvinylidene fluoride (PVdF), epoxy resins, silicone resins, and mixtures thereof.

From the viewpoint of electrical stability, polyethylene (PE), polypropylene (PP), polymethylpentene (PMP), and polycycloolefin (PCO) are preferable, and polyethylene (PE), polypropylene (PP), and polymethylpentene (PMP) are more preferable.

Examples of separators include well-known separators for lithium ion batteries such as a porous film made of polyethylene or polypropylene, a laminated film of a porous polyethylene film and porous polypropylene, non-woven fabrics consisting of synthetic fibers (such as polyester fibers and aramid fibers), glass fibers, or the like, and those with fine ceramic particles such as silica, alumina, or titania attached to their surfaces.

The positive electrode active material layer and the negative electrode active material layer contain an electrolytic solution.

As electrolytic solutions, well-known electrolytic solutions which contain an electrolyte and a non-aqueous solvent and are used for manufacturing well-known lithium ion batteries can be used.

As electrolytes, electrolytes used in well-known electrolytic solutions can be used, and examples thereof include lithium salts of inorganic anions such as LiPF₆, LiBF₄, LiSbF₆, LiAsF₆, LiClO₄, and LiN(FSO₂)₂ and lithium salts of organic anions such as LiN(CF₃SO₂)₂, LiN(C₂F₅SO₂)₂, and LiC(CF₃SO₂)₃. Among these, LiN(FSO₂)₂ is preferable from the viewpoints of battery output and charge-discharge cycle characteristics.

As solvents, non-aqueous solvents used in well-known electrolytic solutions can be used, and examples thereof include lactone compounds, cyclic or chain carbonic acid esters, chain carboxylic acid esters, cyclic or chain ethers, phosphoric acid esters, nitrile compounds, amide compounds, sulfones, sulfolane, and mixtures thereof.

Next, a frame member will be described.

A material constituting a frame member is not particularly limited as long as it is durable against an electrolytic solution, but a polymer material is preferable.

The polymer material may be a thermosetting polymer material. Specific examples thereof include an epoxy resin, a polyolefin resin, a polyester resin, a polyurethane resin, and a polyvinylidene fluoride resin, and an epoxy resin is preferable because it is highly durable and easy to handle.

The polymer material may be a thermoplastic polymer material. Specifically, the material preferably includes one or more selected from the group consisting of an ethylene-vinyl acetate copolymer, maleic acid anhydride-modified polyethylene, and acid-modified polypropylene.

The frame member may consist of a positive electrode frame member and a negative electrode frame member. For the positive electrode frame member and the negative electrode frame member, different materials may be used, or the same materials may be used. It is preferable that the frame member consist of a positive electrode frame member and a negative electrode frame member and that the positive electrode frame member and the negative electrode frame member be fixed to each other with a peripheral edge portion of a separator sandwiched therebetween.

In the battery pack of the present invention, two or more unit cells are enclosed in an exterior body. The material of the exterior body is not particularly limited as long as two or more unit cells can be enclosed, but it is preferable that the exterior body have a form and be made of a flexible material that changes its shape to follow the shape of the stacked body of the unit cells when two or more unit cells are enclosed and pressurized.

As the flexible exterior body, an aluminum laminated film whose inner surface is insulated can be preferably used. The thickness of the exterior body is preferably 100 to 300 μm from the viewpoint of having appropriate flexibility and strength.

In addition, as a non-flexible exterior body, a metal can whose inner surface is insulated can be used.

As shown in FIG. 1, it is preferable to draw out a lead-out terminal such as a high voltage tab from the exterior body.

### Second Embodiment

A battery pack of a second embodiment includes: an integrated insulator (A1) on side surfaces of a stacked body constituting the battery pack. The second embodiment differs from the first embodiment in that the insulators (A1) provided on the side surfaces are not connected to each other and are separate members.

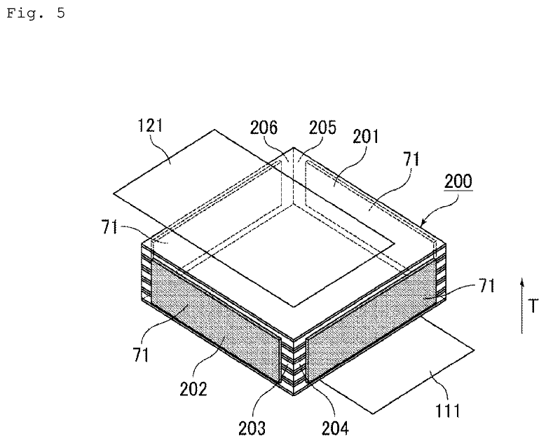

FIG. 5 is a perspective view schematically illustrating another mode in which insulators are provided on side surfaces of the stacked body.

The stacked body 200 is the same as that described in the first embodiment.

FIG. 5 shows a mode in which insulators 71 are each provided on a first side surface 203, a second side surface 204, a third side surface 205, and a fourth side surface 206 of the stacked body 200.

The insulators 71 provided on the side surfaces of the stacked body are separate members. Each insulator covers across the boundaries between the unit cells on the side surfaces of the stacked body, and therefore, close contact between resin current collectors of the vertically adjacent unit cells can be maintained.

### Third Embodiment

A battery pack of a third embodiment includes: a plurality of insulators (A1) on each side surface of a stacked body constituting the battery pack.

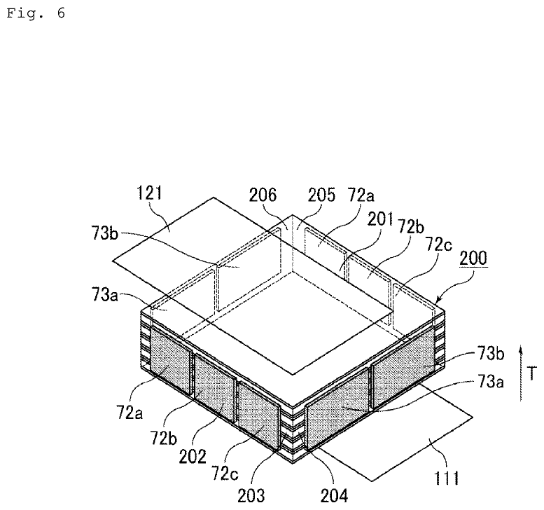

FIG. 6 is a perspective view schematically illustrating still another mode in which insulators are provided on side surfaces of the stacked body.

The stacked body 200 is the same as that described in the first embodiment.

FIG. 6 shows a mode in which three insulators (an insulator 72a, an insulator 72b, and an insulator 72c) are provided on each of the first side surface 203 and the third side surface 205 of the stacked body 200. In addition, a mode is shown in which two insulators (an insulator 73a and an insulator 73b) are provided on each of the second side surface 204 and the fourth side surface 206 of the stacked body 200.

As shown in FIG. 6, the number of insulators provided on each side surface of the stacked body may be different.

The insulators provided on the side surfaces of the stacked body cover across the boundaries between the unit cells on the side surfaces of the stacked body, and therefore, close contact between resin current collectors of the vertically adjacent unit cells can be maintained.

### Fourth Embodiment

A battery pack of a fourth embodiment includes: one insulator (A1) on a side surface of a stacked body constituting the battery pack.

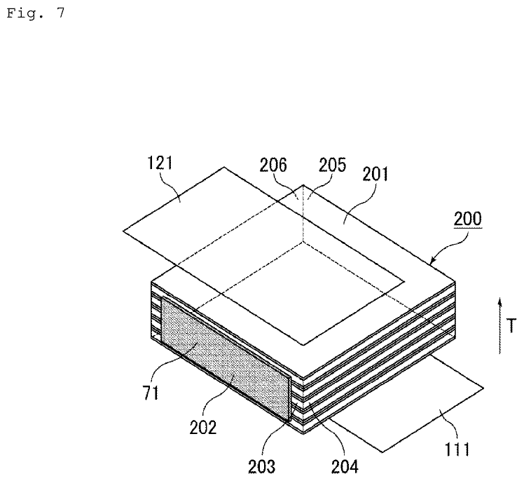

FIG. 7 is a perspective view schematically illustrating another mode in which insulators are provided on side surfaces of the stacked body.

The stacked body 200 is the same as that described in the first embodiment.

FIG. 7 shows a mode in which an insulator 71 is provided on a first side surface 203 of the stacked body 200. No insulator is provided on the other side surfaces (a second side surface 204, a third side surface 205, and a fourth side surface 206) of the stacked body 200.

If an insulator covering across the boundaries between the unit cells is provided on at least one of the side surfaces of the stacked body, close contact between resin current collectors of the vertically adjacent unit cells can be maintained.

### Fifth Embodiment

A battery pack of a fifth embodiment includes: insulators (A1) respectively on two opposing side surfaces of a stacked body constituting the battery pack.

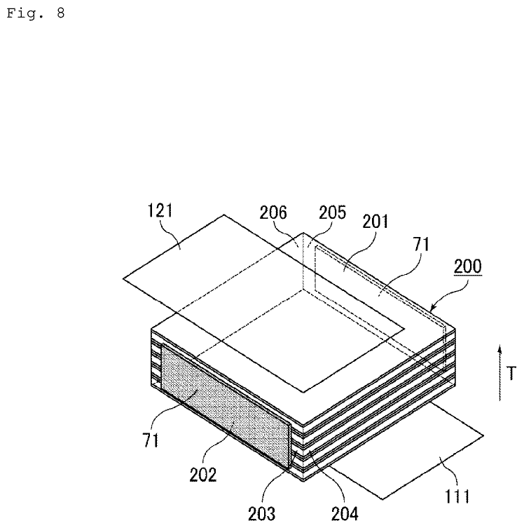

FIG. 8 is a perspective view schematically illustrating still another mode in which insulators are provided on side surfaces of the stacked body.

The stacked body 200 is the same as that described in the first embodiment.

FIG. 8 shows a mode in which insulators 71 are provided on a first side surface 203 and a third side surface 205 of the stacked body 200. No insulator is provided on the other side surfaces (a second side surface 204 and a fourth side surface 206) of the stacked body 200.

If an insulator covering across the boundaries between the unit cells is provided on two opposing side surfaces of the stacked body, close contact between resin current collectors of the vertically adjacent unit cells can be maintained. This mode is more highly effective than a mode in which an insulator is provided on only one side surface of the stacked body or a mode in which insulators are provided on only adjacent two side surfaces of the stacked body (for example, only the first side surface 203 and the second side surface 204 of the stacked body 200).

### Sixth Embodiment

A battery pack of a sixth embodiment includes: insulators (A1) extending from a side surface of a stacked body to an upper surface and a lower surface.

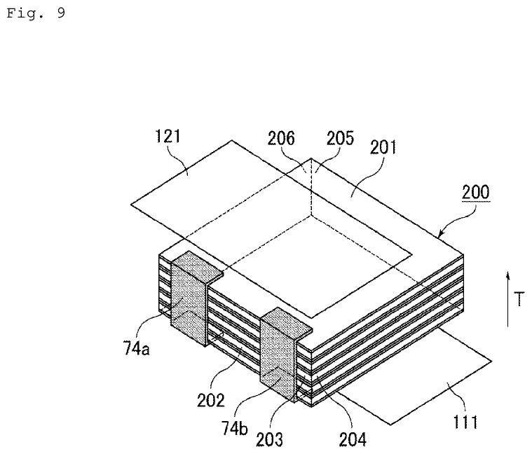

FIG. 9 is a perspective view schematically illustrating still another mode in which insulators are provided on a side surface of the stacked body.

The stacked body 200 is the same as that described in the first embodiment.

FIG. 9 shows a mode in which two insulators (an insulator 74a and an insulator 74b) covering a part of an upper surface 201 and a part of a lower surface 202 extending from a first side surface 203 of the stacked body 200 are provided.

If the insulators extend from the side surface of the stacked body to the upper surface and the lower surface, misalignment of unit cells can be more effectively prevented, and close contact between resin current collectors of the vertically adjacent unit cells can be more effectively maintained.

### Seventh Embodiment

A battery pack of a seventh embodiment includes: a buffering material between an exterior body and an insulator, in which the buffering material contains gas adsorption particles.

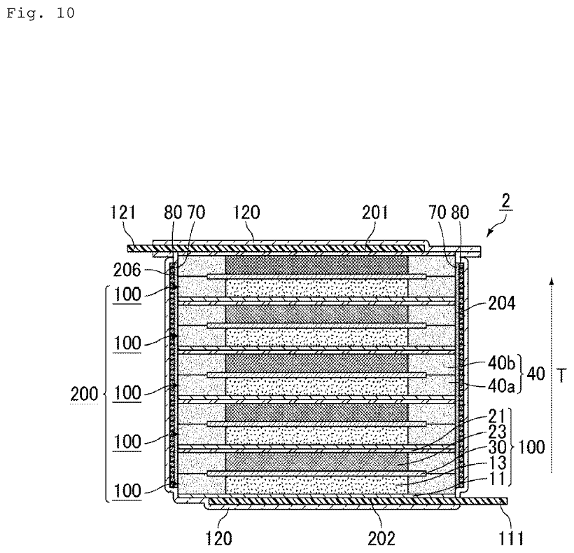

FIG. 10 is a cross-sectional view schematically illustrating one example of a battery pack having a buffering material between an exterior body and an insulator.

A battery pack 2 shown in FIG. 10 includes a buffering material 80 between an exterior body 120 and an insulator 70, in which the buffering material contains gas adsorption particles.

If the buffering material contains gas adsorption particles, gases generated during charging and discharging of a lithium ion battery can be suitably adsorbed.

Gases may be generated inside a lithium ion battery when it is, for example, stored, transported, or used at high temperatures, but the effect of gas generation can be suppressed by gas adsorption particles adsorbing gasses.

As a result, misalignment of vertically adjacent unit cells is prevented, and an internal resistance value of the battery pack is prevented from increasing.

The gas adsorption particles are preferably one or more selected from the group consisting of activated carbon, zeolites, silica, and alumina. In addition, the gas adsorption particles are preferably porous.

The volume average particle diameter of the gas adsorption particles is preferably 500 μm to 2 mm and more preferably 1 to 2 mm.

The larger the volume average particle diameter of the gas adsorption particles, the larger the amount of gas adsorption particles per unit area, which is advantageous from the viewpoint of increasing gas adsorption performance, and the volume average particle diameter of the gas adsorption particles is preferably 500 μm or more.

If the volume average particle diameter of the gas adsorption particles exceeds 2 mm, the volume occupied by the gas adsorption particles in the battery pack increases, leading to a decrease in energy density per volume.

In the present specification, the volume average particle diameter of particles (such as gas adsorption particles) means a particle diameter (Dv50) at 50% cumulative value in particle size distribution obtained through the Microtrac method (laser diffraction/scattering method). The Microtrac method is a method of determining particle size distribution using scattered light obtained by irradiating particles with a laser beam. Microtrac or the like manufactured by Nikkiso Co., Ltd. can be used to measure the volume average particle diameter of particles.

The specific surface area of the gas adsorption particles is preferably 1 to 2,000 m²/g and more preferably 1 to 100 m²/g.

If the specific surface area of the gas adsorption particles is within the above-described ranges, gases generated during charging and discharging of a lithium ion battery can be suitably adsorbed.

In the present specification, the specific surface area of the gas adsorption particles is a value measured as a BET specific surface area according to “JIS Z8830, Method for Measuring Specific Surface Area of Powder (Solid) by Gas Adsorption.”

The gas adsorption particles preferably have a content of 40 to 120 mg/cm² per unit area of the buffering material.

The gas adsorption particles can be used by being adhered on side surfaces of a stacked body as a sheet integrated with an insulator. The basis weight [mg/cm²] of this sheet can be thought as a content of gas adsorption particles per unit area of a buffering material. Since the contribution of the weight of the insulator included in the basis weight of the sheet is small, the basis weight may be equated with the content of gas adsorption particles per unit area of the buffering material.

The larger the content of gas adsorption particles per unit area of the buffering material, the larger the amount of gas adsorption particles per unit area, which is advantageous from the viewpoint of increasing the gas adsorption performance. However, if content of gas adsorption particles per unit area of the buffering material is too high, the volume occupied by the gas adsorption particles in the battery pack increases, leading to a decrease in energy density per volume.

The buffering material may contain a resin material or pulp in addition to the gas adsorption particles.

Examples of such buffering materials include sheets made of gas adsorption particles and a resin material or pulp, and examples of products thereof include contaminated gas adsorption sheet (GasQ (registered trademark) manufactured by Archival Conservation and Enclosures Co., Ltd. and Zeo Sheet (manufactured by Mihama Corporation).

In addition, in a case where a buffering material contains gas adsorption particles and other components, the weight proportion of the gas adsorption particles is preferably 50 weight % or more based on the weight of the buffering material.

If the weight proportion of the gas adsorption particles is within this range, the strength of the buffering material and the gas adsorption properties are well balanced. Therefore, misalignment of unit cells can be suppressed and the internal resistance value of a battery pack can be further reduced.

In addition, it is preferable that the battery pack of the present invention further have an insulator (A2) between a buffering material and an exterior body.

In order for the battery pack to include an insulator (A1), a buffering material, and an insulator (A2) between a stacked body and an exterior body, three-layer-structured insulating tape can be used.

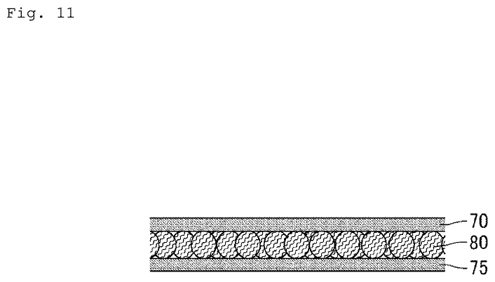

FIG. 11 is a cross-sectional view schematically illustrating one example of insulating tape having a three-layer structure of an insulator, a buffering material, and an insulator.

FIG. 11 shows insulating tape consisting of three layers of an insulator 70, a buffering material 80, and an insulator 75.

The material and thickness of the insulator 70 and the insulator 75 may be the same as or different from each other. The insulator 70 is an insulator (A1) placed in contact with the side surface of a stacked body, and the insulator 75 is an insulator (A2) placed in contact with an exterior body.

The buffering material 80 preferably contains gas adsorption particles.

The surface of the insulator (A1) coming into contact with the side surface of the stacked body has adhesive strength.

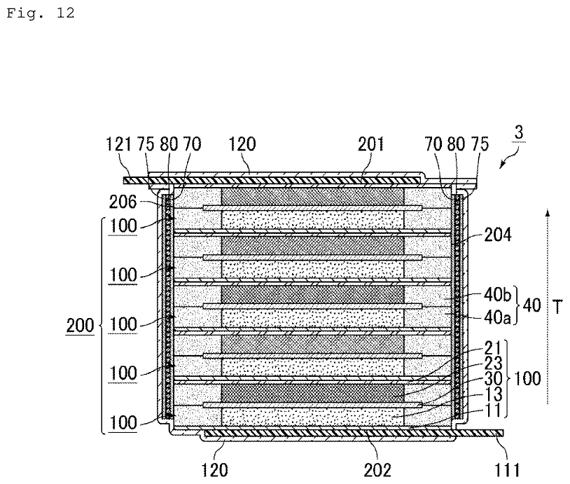

FIG. 12 is a cross-sectional view schematically illustrating one example of a battery pack in which the three-layer-structured insulating tape shown in FIG. 11 is placed between a stacked body and an exterior body.

In a battery pack 3 shown in FIG. 12, an insulator 70 comes into contact with the side surface (a second side surface 204 and a fourth side surface 206) of a stacked body 200, and a buffering material 80 and an insulator 75 are placed between the insulator 70 and an exterior body 120. The insulator 75 is the insulator (A2) placed between the buffering material 80 and the exterior body 120.

With such a configuration, a buffering material containing gas adsorption particles can be provided on the side surface of the stacked body 200 with a simple procedure by adhering three-layer-structured insulating tape on the side surface of the stacked body 200.

A method for manufacturing the battery pack of the present invention is not particularly limited but the battery pack of the present invention can be obtained such that, after producing unit cells and a stacked body, an integrated insulator (A1) covering across the boundaries between the unit cells is provided with a procedure such as adhering insulating tape that serves as an insulator on side surfaces of the stacked body, and the stacked body provided with the insulator is enclosed with an exterior body.

In addition, three-layer-structured insulating tape as shown in FIG. 11 can be obtained by sandwiching gas adsorption particles between adhesive insulating tapes, and a battery pack provided with a buffering material having gas adsorption particles between an exterior body and the insulators by adhering the three-layer-structured insulating tape on the side surfaces of a stacked body can be obtained.

### Examples

Next, the present invention will be specifically described with reference to examples, but is not limited to the examples as long as the examples do not depart from the gist of the present invention. Unless otherwise specified, the units “parts” and “%” respectively mean parts by weight and weight %.

### Production of Polymer Compound for Coating

150 parts of DMF was added to a four-neck flask equipped with a stirrer, a thermometer, a reflux condenser tube, a dropping funnel, and a nitrogen gas introduction tube, and the temperature was raised to 75° C. Next, a monomer composition containing 91 parts of acrylic acid, 9 parts of methyl methacrylate, and 50 parts of DMF and an initiator solution obtained by dissolving 0.3 parts of 2,2′-azobis (2,4-dimethylvaleronitrile) and 0.8 parts of 2,2′-azobis (2-methylbutyronitrile) in 30 parts of DMF were continuously added dropwise to the four-neck flask using a dropping funnel over 2 hours under stirring while blowing nitrogen into the four-neck flask to perform radical polymerization. After the completion of the dropwise addition, the reaction was continued at 75° C. for 3 hours. Next, the temperature was raised to 80° C. and the reaction was continued for 3 hours to obtain a copolymer solution at a resin concentration of 30%. The resulting copolymer solution was transferred to a Teflon (registered trademark) vat and dried under reduced pressure at 150° C. and 0.01 MPa for 3 hours, and DMF was distilled off to obtain a copolymer. This copolymer was coarsely pulverized with a hammer, and then further pulverized in a mortar to obtain a powdery polymer compound for coating.

### Production of Electrolytic Solution

LiFSI (LiN(FSO₂)₂) was dissolved in a mixed solvent of ethylene carbonate (EC) and propylene carbonate (PC) (EC:PC volume ratio of 3:7) at a rate of 2.0 mol/L to produce an electrolytic solution.

### Production of Resin Current Collector

70 parts of polypropylene [trade name “SunAllomer PL500A” manufactured by SunAllomer Ltd.], 25 parts of a carbon nanotube [trade name “FloTube9000” manufactured by CNano], and 5 parts of a dispersant [trade name “Umex 1001” manufactured by Sanyo Chemical Industries, Ltd.] were melt-kneaded using twin-screw extruder under the conditions of 200° C. and 200 rpm to obtain a resin mixture.

The resulting resin mixture was passed through a T-die extrusion film molding machine, and elongated and rolled to obtain a conductive film for a resin current collector with a film thickness of 50 μm. Next, the resulting conductive film for a resin current collector was cut into 400 mm×500 mm, and nickel vapor deposition was performed on one surface to obtain a resin current collector.

### Production of Coated Negative Electrode Active Material Particles

1 part of a polymer compound for coating was dissolved in 3 parts of DMF to obtain a polymer compound solution for coating.

76 parts of negative electrode active material particles (hard carbon powder, volume average particle diameter of 25 μm) were placed in a universal mixer, High Speed Mixer FS25 [manufactured by Earthtechnica Co., Ltd. ], 9 parts of the polymer compound solution for coating was added dropwise thereto over 2 minutes in a state where the negative electrode active material particles were stirred at room temperature at 720 rpm, and the mixture was further stirred for 5 minutes.

Subsequently, in a state where the mixture was stirred, 9 parts of acetylene black [Denka Black (registered trademark) manufactured by Denka Company Limited] as a conductive agent, 2 parts of a carbon nanofiber [manufactured by Teijin Limited], and 4 parts of glass-ceramic particles (trade name “Lithium Ion Conductive Glass Ceramics LICGC™ PW-01 (1 μm)” [manufactured by Ohara Inc. ], volume average particle diameter of 1,000 nm) were added thereto in portions for 2 minutes, and stirring was continued for 30 minutes.

Thereafter, the pressure was reduced to 0.01 MPa while maintaining the stirring, and then the temperature was raised to 140° C. while maintaining the stirring and decompression degree, and volatile contents were distilled off while maintaining the stirring, decompression degree, and temperature for 8 hours.

The resulting powder was classified with a sieve with openings of 200 μm to obtain coated negative electrode active material particles.

### Production of Coated Positive Electrode Active Material Particles

1 part of a polymer compound for coating was dissolved in 3 parts of DMF to obtain a polymer compound solution for coating.

84 parts of positive electrode active material particles (LiNi_{0.8}Co_{0.15}Al_{0.05}O₂ powder, volume average particle diameter of 4 μm) were placed in a universal mixer, High Speed Mixer FS25 [manufactured by Earthtechnica Co., Ltd.], 9 parts of the polymer compound solution for coating was added dropwise thereto over 2 minutes in a state where the positive electrode active material particles were stirred at room temperature at 720 rpm, and the mixture was further stirred for 5 minutes.

Subsequently, in a state where the mixture was stirred, 3 parts of acetylene black [Denka Black (registered trademark) manufactured by Denka Company Limited]as a conductive agent and 4 parts of glass-ceramic particles [trade name: Lithium Ion Conductive Glass Ceramics LICGC™ PW-01 (1 μm), manufactured by Ohara Inc.] were added thereto in portions for 2 minutes, and stirring was continued for 30 minutes.

Thereafter, the pressure was reduced to 0.01 MPa while maintaining the stirring, and then the temperature was raised to 140° C. while maintaining the stirring and decompression degree, and volatile contents were distilled off while maintaining the stirring, decompression degree, and temperature for 8 hours.

The resulting powder was classified with a sieve with openings of 200 μm to obtain coated positive electrode active material particles.

### Production of Negative Electrode

A negative electrode frame member (inner dimensions 37 cm×40 cm, outer dimensions 38.6 cm×41.4 cm) made of polyolefin resin molded into a square ring shape was prepared.

42 parts of an electrolytic solution and 4.2 parts of a carbon fiber [Donacarbo Milled S- 243 manufactured by Osaka Gas Chemicals Co., Ltd., average fiber length of 500 μm, average fiber diameter of 13 μm, electric conductivity of 200 mS/cm] were mixed with each other using a planetary stirring type mixing and kneading device {Awatori Rentaro (registered trademark) [manufactured by Thinky Ltd.]} at 2,000 rpm for 5 minutes, and then, 30 parts of the above-described electrolytic solution and 206 parts of the above-described coated negative electrode active material particles were added thereto. Thereafter, the mixture was further mixed using Awatori Rentaro at 2,000 rpm for 2 minutes and 20 parts of the above-described electrolytic solution was further added thereto. Then, the mixture was stirred using Awatori Rentaro at 2,000 rpm for 1 minute, and 2.3 parts of the above-described electrolytic solution was further added thereto. Thereafter, the mixture was stirred using Awatori Rentaro at 2,000 rpm for 2 minutes to produce a negative electrode active material composition.

The above-described negative electrode frame member was placed on a resin current collector, and the negative electrode active material composition was applied inside the frame of the negative electrode frame member to produce a negative electrode. Further, the electrolytic solution was injected into the negative electrode active material layer.

### Production of Positive Electrode

A positive electrode frame member (inner dimensions 37 cm×40 cm, outer dimensions 38.6 cm×41.4 cm) made of polyolefin resin molded into a square ring shape was prepared. 42 parts of an electrolytic solution and 4.2 parts of a carbon fiber [Donacarbo Milled S- 243 manufactured by Osaka Gas Chemicals Co., Ltd., average fiber length of 500 μm, average fiber diameter of 13 μm, electric conductivity of 200 mS/cm] were mixed with each other using a planetary stirring type mixing and kneading device {Awatori Rentaro [manufactured by Thinky Ltd. ]} at 2,000 rpm for 5 minutes, and then, 30 parts of the above-described electrolytic solution and 206 parts of the above-described coated positive electrode active material particles were added thereto. Thereafter, the mixture was further mixed using Awatori Rentaro at 2,000 rpm for 2 minutes and 20 parts of the above-described electrolytic solution was further added thereto. Then, the mixture was stirred using Awatori Rentaro at 2,000 rpm for 1 minute, and 2.3 parts of the above-described electrolytic solution was further added thereto. Thereafter, the mixture was stirred using Awatori Rentaro at 2,000 rpm for 2 minutes to produce a positive electrode active material composition.

The above-described positive electrode frame member was placed on a resin current collector, and the positive electrode active material composition was applied inside the frame of the positive electrode frame member to produce a positive electrode. Further, the electrolytic solution was injected into the positive electrode active material layer.

### Production of Unit Cell

The produced negative electrode and positive electrode were stacked together with a separator, the overlapping portion of the positive electrode frame member and the negative electrode frame member was heat-sealed through heating and pressurizing to produce a unit cell. As the separator, #3501 manufactured by Celgard was used.

### Preparation of Insulator

The following were prepared as insulators.

Insulator 1-1: Kapton tape 650S (manufactured by Teraoka

Seisakusho Co., Ltd.)

Insulator 1-2: Polyester film tape 25BN (Okamoto) Insulator 1-3: ELEP masking tape N-380R (Nitto Denko Corporation)

Insulator 1-4: Curing P-Cut Tape No. 4140 (manufactured by Teraoka Seisakusho Co., Ltd.)

Insulator 2: One obtained by adhering double-sided tape, Nicetack NW-50 (manufactured by Nichiban Co., Ltd.), on the side surface of a buffering material (a gas adsorption sheet made of gas adsorption particles and a resin material or pulp) to make it sticky. Zeolites were used as gas adsorption particles, the basis weight was 25 mg/cm², and the volume average particle diameter of Zeolites was 500 μm.

The specifications of the gas adsorption particles are as follows.

Activated carbon: Product name “Powdered Activated Carbon KD-CAB,” volume average particle diameter of 100 μm, manufacturer of Universal Engraving Systems Inc.

Silica: Product name “Silica Powder,” volume average particle diameter of 50 μm, manufacturer of Maruto

Alumina 1: Product name “Activated Alumina AA-101,” volume average particle diameter of 12 μm, manufacturer of Nippon Light Metal Company, Ltd.

Alumina 2: Product name “Activated Alumina D-201,” volume average particle diameter of 5,000 μm, manufacturer of Union Showa K.K.

Zeolite 1: Product name “Molecular Sieve 4A Pellet,” volume average particle diameter of 500 μm, manufacturer of Tomoe Engineering Co., Ltd.

Zeolite 2: Product name “Molecular Sieve 4A Pellet,” volume average particle diameter of 700 μm, manufacturer of Union Showa K.K.

Zeolite 3: Product name “Molecular Sieve 4A Pellet,” volume average particle diameter of 1,600 μmφ×5,000 μm (cylindrical), manufacturer of Union Showa K.K.

Zeolite 4: Product name “13X Beads,” volume average particle diameter of 2,500 μm, manufacturer of Union Showa K.K.

Zeolite 5: Product name “5A Beads,” volume average particle diameter of 3,000 μm, manufacturer of Union Showa K.K.

Zeolite 1 and Zeolite 2 were prepared by pulverizing Zeolite 3 in a mortar and adjusting the average particle diameter with a sieve.

Since Zeolite 3 has a cylindrical shape, the diameter of a circle is shown as the volume average particle diameter shown in Table 1.

### Examples 1 to 16, Comparative Example 1

### Production of Battery Pack 40 unit cells were stacked to obtain a stacked body. High voltage tabs were joined to the upper and lower surfaces of the stacked body.

In Examples 1 to 16, the adhesive surface of an insulator (A1) was adhered to the side surface of the stacked body.

Aspects in which insulators were provided are summarized in Table 1.

In Comparative Example 1, no insulator was adhered.

A covering aspect in a case of covering four side surfaces of a stacked body is the aspect shown in FIG. 5 in which insulators are provided on the side surfaces of the stacked body constituting a battery pack.

A covering aspect in a case of covering two side surfaces of a stacked body is the aspect shown in FIG. 8 in which insulators are provided on two opposing side surfaces of the stacked body constituting a battery pack.

A covering aspect in a case of covering one side surface of a stacked body is the aspect shown in FIG. 7.

Example 3 is an aspect in which no insulator (A2) was provided and is the aspect shown in FIG. 10.

Examples 4 to 13 are aspects in which insulators (A2) were provided and are the aspect shown in FIG. 12.

Examples 14 to 16 are aspects in which the type of insulator (A1) was changed from Example 2, and the 180° peeling adhesive strength of the insulator (A1) to a PET plate was different from that in Example 2.

For the insulator (A1) used in each example, the 180° peeling adhesive strength of the insulator to a PET plate was measured according to JIS Z 0237.

A PET plate with a width of 25 mm and a thickness of 3 mm was prepared as an adherend, the adhesive surface of the insulator (A1) was brought into contact with the PET plate and pressed with a roller to adhere the test piece on the PET plate, and the 180° peeling adhesive strength was measured according to JIS Z 0237.

The peeling adhesive strength was measured using a force gauge (AD-4932A-50N: manufactured by A&D Company, Limited).

The measurement results are summarized in Table 1.

The battery packs manufactured in the examples and comparative examples were subjected to a heating and vibration test to evaluate the characteristics of the battery packs before and after the tests. The evaluation results are summarized in Table 1.

### Heating and Vibration Test

Each battery pack was held in a constant-temperature tank at 72° C. for 60 hours and subjected to a heating test.

The battery pack that underwent the heating test was fixed in a vibration testing device (V8-440 Metric SHAKER), and vibrations of 7 Hz-200 Hz-7 Hz were applied for 15 minutes×12 times in each of the X-, Y-, and 2-directions. The test time was 3 hours in each direction for a total of 9 hours.

This heating and vibration test is a test conforming to T2 (thermal test) and T3 (vibration test) of the lithium ion battery UN recommended transport test UN38.3.

### Evaluation of Internal Resistance Value Before and After Heating and Vibration Test

A terminal of Battery HiTester (manufactured by Hioki E.E. Corporation, BT3563A) was connected to a high voltage tab of the battery pack after the test, and the internal resistance value (Q/MD: resistance value per battery pack) at 1000 Hz was measured in a state where the temperature was adjusted to 25° C.

The internal resistance value of the battery pack before the heating and vibration test was measured.

### Evaluation of Misalignment After Heating and Vibration Test

A stacked body of unit cells was taking out of an exterior body, and the misalignment of the unit cells when seen from above the stacked body was measured.

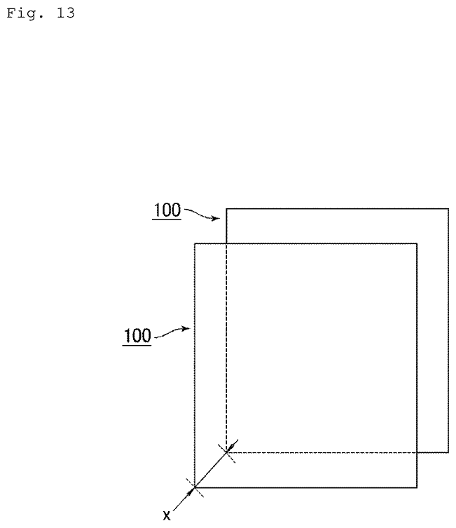

FIG. 13 is a schematic view illustrating positions at which misalignment of unit cells is measured.

As shown in FIG. 13, the misalignment of a plurality of unit cells 100 was measured as the length [mm] indicated by a double-headed arrow X.

### Evaluation of Breakage of Resin Current Collectors After Heating and Vibration Test

A stacked body was disassembled, unit cells were taken out one by one, and it was observed whether there is breakage caused in resin current collectors.

### Energy Density of Battery Pack

The energy density (Wh/L) per volume (L: liter) of a battery pack was determined from the ratio of the volume of the battery pack to the volume of the stacked unit portion in the battery pack.

TABLE 1

| | Insulator (A1) | | | Buffering material | | | |
|---|---|---|---|---|---|---|---|
| | | | 180° | (gas adsorption particles) | | | |
| | | Number | peeling | | | | Volume |
| | | of side | adhesive | | | | average |
| | | surfaces | strength to | Presence | | Basis | particle |
| | | to be | PET plate | and | | weight | diameter |
| | Types | covered | (N/25 mm) | absence | Types | [mg/cm²] | [μm] |
| Example 1 | Insulator 1-1 | 1 | 1.7 | Absent | — | — | — |
| Example 2 | Insulator 1-1 | 4 | 1.7 | Absent | — | — | — |
| Example 3 | Insulator2* | 4 | 3.9 | Present | Zeolite | 25 | 500 |
| Example 4 | Insulator 1-1 | 4 | 1.7 | Present | Zeolite 1 | 25 | 500 |
| Example 5 | Insulator 1-1 | 4 | 1.7 | Present | Alumina 1 | 0.5 | 12 |
| Example 6 | Insulator 1-1 | 4 | 1.7 | Present | Silica | 2.5 | 50 |
| Example 7 | Insulator 1-1 | 4 | 1.7 | Present | Activated | 5 | 100 |
| | | | | | carbon | | |
| Example 8 | Insulator 1-1 | 4 | 1.7 | Present | Zeolite 2 | 40 | 700 |
| Example 9 | Insulator 1-1 | 4 | 1.7 | Present | Zeolite 3 | 110 | 1600 |
| Example 10 | Insulator 1-1 | 2 | 1.7 | Present | Zeolite 3 | 110 | 1600 |
| | | (Opposing) | | | | | |
| Example 11 | Insulator 1-1 | 4 | 1.7 | Present | Zeolite 4 | 120 | 2500 |
| Example 12 | Insulator 1-1 | 4 | 1.7 | Present | Zeolite 5 | 150 | 3000 |
| Example 13 | Insulator 1-1 | 4 | 1.7 | Present | Alumina 2 | 250 | 5000 |
| Example 14 | Insulator 1-2 | 4 | 0.2 | Absent | — | — | — |
| Example 15 | Insulator 1-3 | 4 | 0.5 | Absent | — | — | — |
| Example 16 | Insulator 1-4 | 4 | 3.8 | Absent | — | — | — |
| Comparative | None | None | — | Absent | — | — | — |
| Example 1 | | | | | | | |
| | | | Evaluation items | | | | |
| | | | Internal | Internal | | | Energy |
| | | Insulator | resistance | resistance | | | density |
| | | (A2) | value | value | | Breakage | of |
| | | Presence | [before | [after | Misalignment | of resin | battery |
| | | and | test | test | after test | current | pack |
| | | absence | Ω/MD] | Ω/MD] | [mm] | collector | [Wh/L] |
| | Example 1 | None | 0.5 | 180 | 10 mm | Broken | 255 |
| | Example 2 | None | 0.5 | 70 | 1 mm or less | None | 255 |
| | Example 3 | None | 0.3 | 26 | 1 mm or less | None | 255 |
| | Example 4 | Insulator 1-4 | 0.3 | 22 | 1 mm or less | None | 255 |
| | Example 5 | Insulator 1-4 | 0.4 | 50 | 1 mm or less | None | 255 |
| | Example 6 | Insulator 1-4 | 0.3 | 45 | 1 mm or less | None | 255 |
| | Example 7 | Insulator 1-4 | 0.3 | 43 | 1 mm or less | None | 255 |
| | Example 8 | Insulator 1-4 | 0.3 | 9 | 1 mm or less | None | 255 |
| | Example 9 | Insulator 1-4 | 0.3 | 7 | 1 mm or less | None | 255 |
| | Example 10 | Insulator 1-4 | 0.3 | 8 | 1 mm or less | None | 255 |
| | Example 11 | Insulator 1-4 | 0.3 | 7 | 1 mm or less | None | 254 |
| | Example 12 | Insulator 1-4 | 0.3 | 7 | 1 mm or less | None | 253 |
| | Example 13 | Insulator 1-4 | 0.3 | 7 | 1 mm or less | None | 249 |
| | Example 14 | None | 0.5 | 600 | 4 mm | None | 255 |
| | Example 15 | None | 0.5 | 70 | 1 mm or less | None | 255 |
| | Example 16 | None | 0.5 | 70 | 1 mm or less | None | 255 |
| | Comparative | None | 0.5 | 2000 | 20 mm | Broken | 255 |
| | Example 1 | | | | | | |

*Insulator 2 is obtained by adhering double-sided tape on a gas adsorption sheet to make it sticky.

The battery packs of the examples had a significantly lower internal resistance value after the heating and vibration test than the battery pack of Comparative Example 1. In the battery pack of Comparative Example 1, it is thought that the adhesion between resin current collectors deteriorated due to the heating and vibration test and the internal resistance value increased. However, in the battery packs of the examples, misalignment of vertically adjacent unit cells was prevented, and therefore the internal resistance values of the battery packs were prevented from increasing.

In the battery pack of Example 1, since only one side surface of a stacked body was covered by an insulator, the effect of preventing misalignment of unit cells was slightly weak, resulting in misalignment after the test as well as breakage of resin current collectors.

In the battery packs of Examples 2 to 13, 15, and 16, the misalignment of unit cells was 1 mm or less, and no breakage of the resin current collectors occurred. Even in a case where only two opposing side surfaces of a stacked body are covered with insulators as in Example 10, a sufficient effect was obtained.

In a battery pack of Example 14 in which the peeling adhesive strength of insulators to PET is less than 0.5 N/25 mm, the effect of preventing misalignment of unit cells was slightly weak.

Examples 3 to 13 containing gas adsorption particles as a buffering material had lower internal resistance values than Examples 1, 2, and 14 to 16 containing no gas adsorption particles.

In particular, Examples 8 to 13 in which the content of gas adsorption particles was 40 mg/cm² or more per unit area of a buffering material had particularly low internal resistance values.

In addition, in Examples 11 to 13 in which the volume particle diameter of gas adsorption particles exceeded 2,000 μm (2 mm), the energy density of a battery pack was slightly low.

### INDUSTRIAL APPLICABILITY

The battery pack of the present invention can prevent an increase in internal resistance value even if vibrations are applied from outside during battery production, transportation, or use, and therefore, the battery pack can be used in an environment where vibrations are applied.

1. A battery pack comprising:
two or more unit cells including a stacked unit consisting of a set of a positive electrode resin current collector, a positive electrode active material layer, a separator, a negative electrode active material layer, and a negative electrode resin current collector stacked sequentially, a stacked body of the two or more unit cells being enclosed in an exterior body; and
an integrated insulator (A1) covering across boundaries between the unit cells on at least one of the side surfaces of the stacked body.

2. The battery pack according to claim 1, wherein
the insulator (A1) is a material with a peeling adhesive strength of 0.5 N/25 mm or more to a PET plate on at least one surface thereof and covers across the boundaries between the unit cells with the surface having the adhesive strength.

3. The battery pack according to claim 1, further comprising:
a buffering material between the exterior body and the insulator, wherein
the buffering material contains gas adsorption particles.

4. The battery pack according to claim 3, further comprising:
an insulator (A2) between the buffering material and the exterior body.

5. The battery pack according to claim 3, wherein
the gas adsorption particles are one or more selected from the group consisting of activated carbon, zeolites, silica, and alumina.

6. The battery pack according to claim 3, wherein
the gas adsorption particles have a content of 40 to 120 mg/cm² per unit area of the buffering material.

7. The battery pack according to claim 3, wherein
the gas adsorption particles have a volume average particle diameter of 500 μm to 2 mm.

8. The battery pack according to claim 1, further comprising:
insulators (A1) respectively on two opposing side surfaces of the stacked body.

9. The battery pack according to claim 1, further comprising:
an integrated insulator (A1) on all side surfaces of the stacked body.
